(19) United States
(12) Patent Application Publication
(10) Pub. No.: US 2016/0152001 A1
(43) Pub. Date: Jun. 2, 2016

(54) SCREEN PROTECTOR STRUCTURE

(71) Applicant: MATERIALS COATING TECHNOLOGY CORPORATION, TAINAN CITY (TW)

(72) Inventors: YUNG-CHI SU, TAINAN CITY (TW); CHIN-CHANG CHEN, TAINAN CITY (TW); CHEN-PANG LIU, TAINAN CITY (TW)

(21) Appl. No.: 14/641,554

(22) Filed: Mar. 9, 2015

(30) Foreign Application Priority Data
Dec. 1, 2014 (TW) 103221265

(51) Int. Cl. B32B 7/02; B32B 7/12; B32B 27/08; A01N 25/34; B32B 27/20; G06F 1/16; A01N 59/16; A01N 59/20; G02B 1/16; B32B 27/36

(52) U.S. Cl. CPC B32B 7/02; G02B 1/16; B32B 7/12; B32B 27/08; B32B 27/36; B32B 27/20; G06F 1/1613; A01N 59/16; A01N 59/20; A01N 25/34; B32B 2307/21; B32B 2307/42; B32B 2307/584; B32B 2307/70; B32B 2457/20; B32B 2405/00; B32B 2264/105; B32B 2264/101; B32B 2264/12; B32B 2260/025; B32B 2260/046; B32B 2307/7145

(57) ABSTRACT

A screen protector structure is provided with a plurality of functional films and each of the functional films has a substrate. An adhesive layer is combined on the bottom face of each substrate and the functional layer is overlapped and bonded on the top face of the substrate. When in manufacturing, the screen protector can be produced according to customer's designation so that, for example, a fragrance film, an anti-scratch bacteriostatic film, an anti-scratch blue light reduction film, or an anti-scratch antistatic film can be overlapped and bonded together so as to accomplish the manufacturing of the screen protector designated by customer. When the upmost film is out of function due to wearing, it can be torn off and replaced with a new functional film easily.

### BACKGROUND OF INVENTION

1. Field of the Invention

The present invention relates to a screen protector structure, more particularly to a screen protector structure which adopts modular design so as to raise production efficiency, and which is very easy to substitute various functional films.

2. Brief Description of the Prior Art

It is indicated in a research report that existing 3C products such as mobile phone can emit blue light which is very harmful to human's eyes during working of its screens, and is attached with odors and bacteria on the screen of mobile phone at the time of operation and answering. It is this reason that the existing screen protector is added with functions of producing fragrance and blue light filtering in addition to the functions of anti-scratch and anti-wearing. However, in the process of manufacturing, the existing screen protector having the functions of producing fragrance and blue light filtering is to coat blue light filtering agent on the substrate firstly, and then to conduct another coating having different function after the blue light filtering agent coating is dried, finally the fragrance layer is coated so that the fragrant aroma can be dissipated out. The process of repeated coating and drying is very cumbersome in manufacturing, and the outmost fragrance layer will be disappeared quickly due to wearing or other factors after use for a period of time. At this moment, user cannot but to continue the use of non-fragrant screen protector, or to replace with a new screen protector. This will result in user's economic burden and waste of resource.

### SUMMARY OF THE INVENTION

The present invention relates to a screen protector structure, the main object is to provide a screen protector structure which adopts modular design so as to raise production efficiency and which is very easy to substitute various functional films.

In order to achieve above object, the inventor proposes a screen protector of the present invention, having a plurality of functional films, each of the functional films having a substrate, an adhesive layer being combined on the bottom face of the substrate and the top face of each substrate being combined with a concerned functional layer; the screen protector being formed by overlapping the plurality of functional films together in such a manner that the adhesive layer on the bottom face of one functional film is adhered to the functional layer provided on the top face of adjacent functional film.

According to above screen protector, the plurality of functional films can be one selected from: at least one fragrance film with a fragrance layer as its functional layer, at least one anti-scratch bacteriostatic film with an anti-scratch bacteriostatic layer as its functional layer, at least one anti-scratch blue light reduction film with an anti-scratch blue light reduction layer as its functional layer, at least one anti-scratch antistatic film with an anti-scratch antistatic layer as its functional layer, or the combination thereof.

According to above screen protector, the plurality of functional films comprises one anti-scratch blue light reduction film and two fragrance films in which the anti-scratch blue light reduction film is disposed as the bottom film and the two fragrance films are sequentially overlapped over the anti-scratch blue light reduction film.

According to above screen protector, the plurality of functional films comprises one anti-scratch bacteriostatic film and two fragrance films in which the anti-scratch bacteriostatic film is disposed as the bottom film and the two fragrance films are sequentially overlapped over the anti-scratch bacteriostatic film.

According to above screen protector, the plurality of functional films comprises one anti-scratch blue light reduction film and two anti-scratch bacteriostatic films in which the anti-scratch blue light reduction film is disposed as the bottom film and the two anti-scratch bacteriostatic films are sequentially overlapped over the anti-scratch blue light reduction film.

According to above screen protector, the plurality of functional films comprises three pieces of anti-scratch bacteriostatic films sequentially overlapped together.

According to above screen protector, the fragrance layer of the fragrance film is formed by mixing a porous material having a plurality of micro pores, essence and resin together.

According to above screen protector, the anti-scratch bacteriostatic layer of the anti-scratch bacteriostatic film is formed by mixing a group containing metal ions of Fe, Co, Ni, Zn, and Ti, one of nano silver and nano copper, anti-scratch particles, and resin together.

According to above screen protector, the anti-scratch blue light reduction layer of the anti-scratch blue light reduction film is formed by mixing an optical filtering particles made by one of metal and glass, pigment, florescent pigment, anti-scratch particles, and resin together.

According to above screen protector, the anti-scratch antistatic layer of the anti-scratch antistatic film is formed by mixing an antistatic agent, anti-scratch particles, and resin together.

When implemented in this manner, the production of a screen protector designated by customer can be easily accomplished by overlapping various functional films such as a fragrance film, an anti-scratch bacteriostatic film, an anti-scratch blue light reduction film, an anti-scratch antistatic film together. Furthermore, users can easily tear off the upmost functional film when it is out of function, and replace with a new one without disposing of the whole screen protector. Therefore, not only user's economic burden can be lessened but also waste of resource can be avoided.

### BRIEF DESCRIPTION OF ACCOMPANYING DRAWINGS

FIG. 1 is a perspective exploded view of the present invention;

FIG. 2 is a perspective exploded view of the first embodiment of the present invention;

FIG. 3 is a sectional view of the first embodiment of the present invention;

FIG. 4 a perspective exploded view of the second embodiment of the present invention;

FIG. 5 is a sectional view of the second embodiment of the present invention;

FIG. 6 a perspective exploded view of the third embodiment of the present invention;

FIG. 7 is a sectional view of the third embodiment of the present invention.

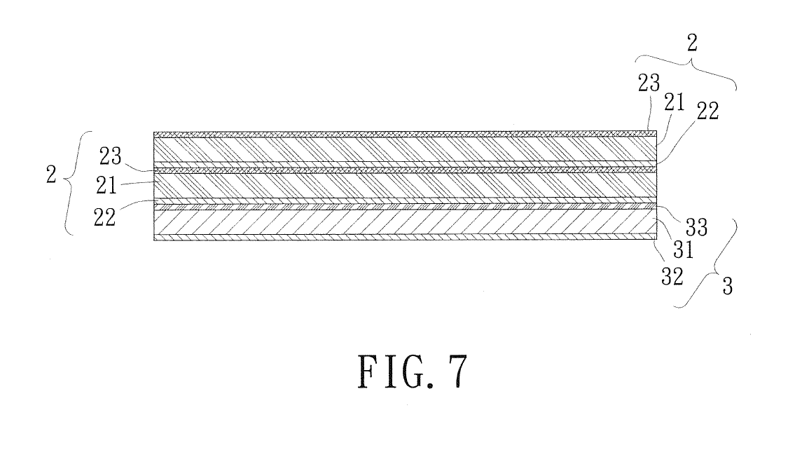

### DETAILED DESCRIPTION OF PREFERRED EMBODIMENTS

The objects, the technical contents and the expected effectiveness of the present invention will become more apparent from the detailed description of the preferred embodiments in conjunction with the accompanying drawings.

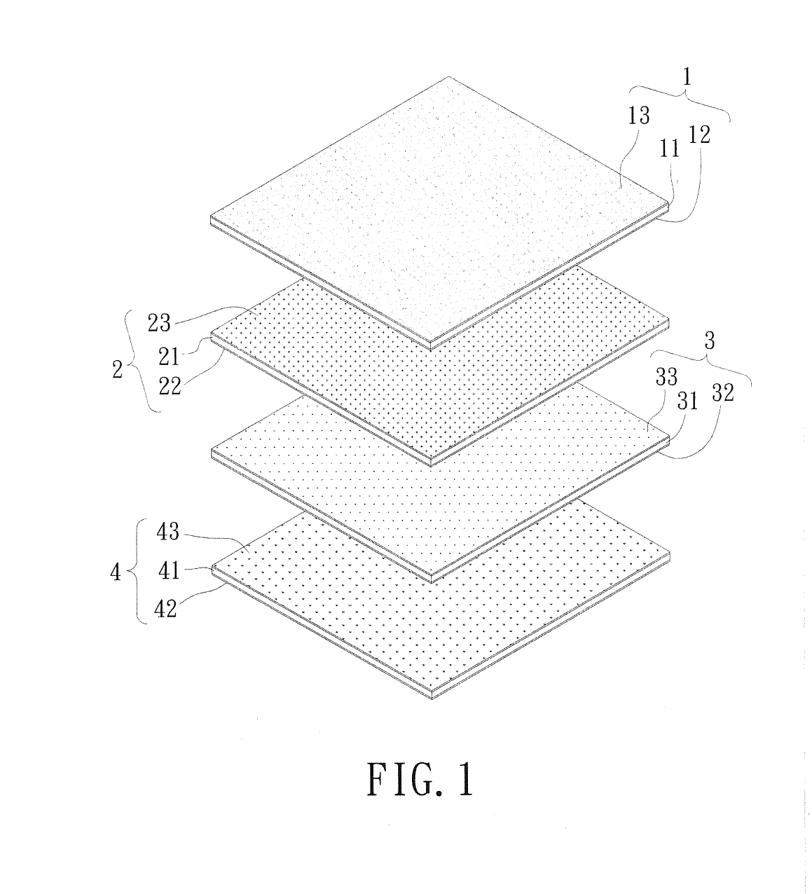

Firstly referring to FIG. 1, the screen protector structure of the present invention mainly comprises a plurality of functional films. Each functional film has a substrate, the bottom face of each substrate is combined with an adhesive layer and the top face of each substrate is combined with a concerned functional layer. The plurality of functional films are overlapped with each other so that the adhesive layer on the bottom face of each functional film is bonded with the functional layer provided on the top face of adjacent functional film. According to the function difference of the functional layer, the functional films of the present invention includes: at least one fragrance film 1, at least one anti-scratch bacteriostatic film 2, at least one anti-scratch blue light reduction film 3 and at least one anti-scratch antistatic film 4.

The fragrance film 1 has a polyethylene terephthalate (PET) substrate 11, an adhesive layer 12 is combined on the bottom face of the substrate 11 and a fragrance layer 13 is provided on the top face of the substrate 11. The fragrance layer 13 is formed by mixing a porous material having a plurality of micro pores, essence and resin together.

The anti-scratch bacteriostatic film 2 has a polyethylene terephthalate (PET) substrate 21, an adhesive layer 22 is combined on the bottom face of the substrate 21 and an anti-scratch bacteriostatic layer 23 is provided on the top face of the substrate 21. The anti-scratch bacteriostatic layer 23 is formed by mixing a group containing metal ions of Fe, Co, Ni, Zn, and Ti, one of nano silver and nano copper, anti-scratch particles, and resin together.

The anti-scratch blue light reduction film 3 has a polyethylene terephthalate (PET) substrate 31, an adhesive layer 32 is combined on the bottom face of the substrate 31 and an anti-scratch blue light reduction layer 33 is provided on the top face of the substrate 31. The anti-scratch blue light reduction layer 33 is formed by mixing an optical filtering particles made by one of metal and glass, pigment, florescent pigment, anti-scratch particles, and resin together.

The anti-scratch antistatic film 4 has a polyethylene terephthalate (PET) substrate 41, an adhesive layer 42 is combined on the bottom face of the substrate 41 and an anti-scratch antistatic layer 43 is provided on the top face of the substrate 41. The anti-scratch antistatic layer. 43 is formed by mixing an antistatic agent, anti-scratch particles, and resin together.

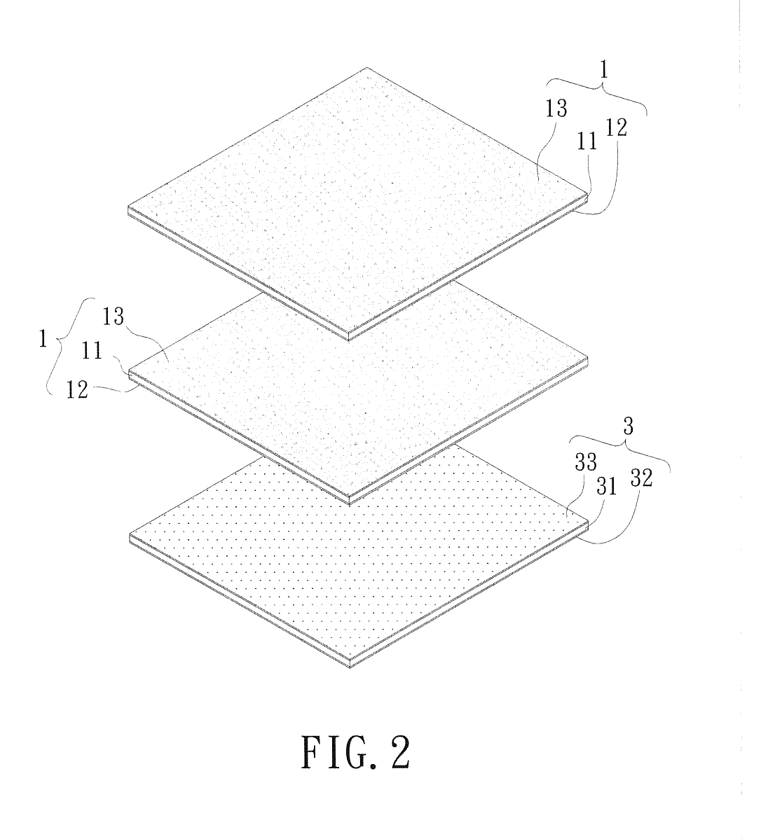

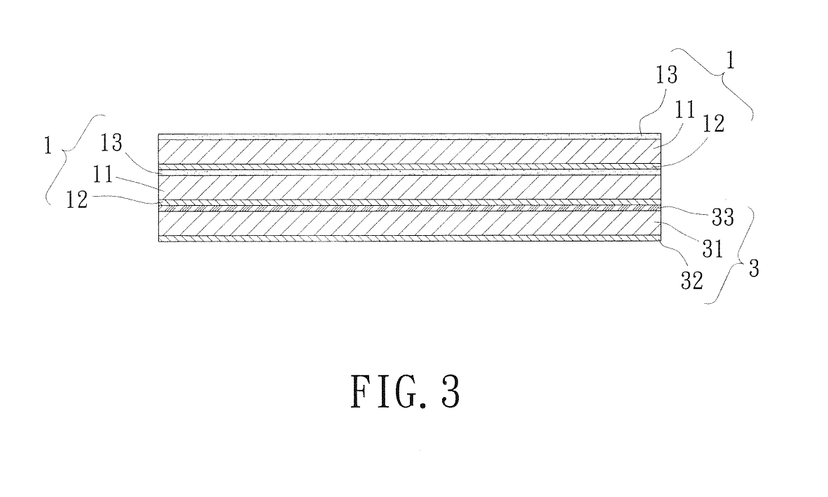

Referring to FIG. 2 and FIG. 3, when manufacturing a screen protector, for example, containing the function of fragrance and blue light reduction according to the need of a customer, an anti-scratch blue light reduction film 3 is set as bottom film, and then a release paper is attached to the adhesive layer 32 of the anti-scratch blue light reduction film 3. Next, a first fragrance film 1 is disposed on the anti-scratch blue light reduction film 3 in such a manner that the adhesive layer 12 of the first fragrance film 1 is adhered to the top face of the anti-scratch blue light reduction layer 33 of the anti-scratch blue light reduction film 3. Then, a second fragrance film 1 is disposed on the first fragrance film 1 in such a manner that the adhesive layer 12 of the second fragrance film 1 is adhered to the top face of the fragrance layer 13 of the first fragrance film 1. Further, a release paper is covered on the top face of the fragrance layer 13 of the second fragrance film 1. In this manner, a three-film structure screen protector with one anti-scratch blue light reduction film 3 and two fragrance films 1 overlapped sequentially from bottom to top is formed.

When in use, the release paper adhered on the adhesive layer 32 of the anti-scratch blue light reduction film 3 is torn off firstly so that the adhesive layer 32 of the anti-scratch blue light reduction film 3 is exposed so as to be adhered onto the screen. In turn, the release paper attached to the top face of the fragrance layer 13 of the upmost fragrance film 1 is torn off so as to expose the fragrance layer 13 of the upmost fragrance film 1 to the outside. Therefore, fragrant aroma can be released from the essence oil contained in the fragrance layer 13 so that users can relieve both physical and mental fatigue feeling after smelling, and the odor attached to the screen of mobile phone can also be eliminated. Furthermore, the blue light component emitted from the screen can be filtered out by the anti-scratch blue light reduction layer 33 of the anti-scratch blue light reduction film 3 so that eye illness of modern people such as macular degeneration or cataracts resulted from irradiation of blue light due to long-time staring on the screen of mobile phone or computer can be avoided. Because the anti-scratch blue light reduction film 3 contains anti-scratch component and the screen protector of the present invention is a structure having more than three sheets of functional films overlapped together, the strength of the screen protector is improved effectively so as to achieve better protection of the screen of mobile phone or computer from the damage of scratch or collision.

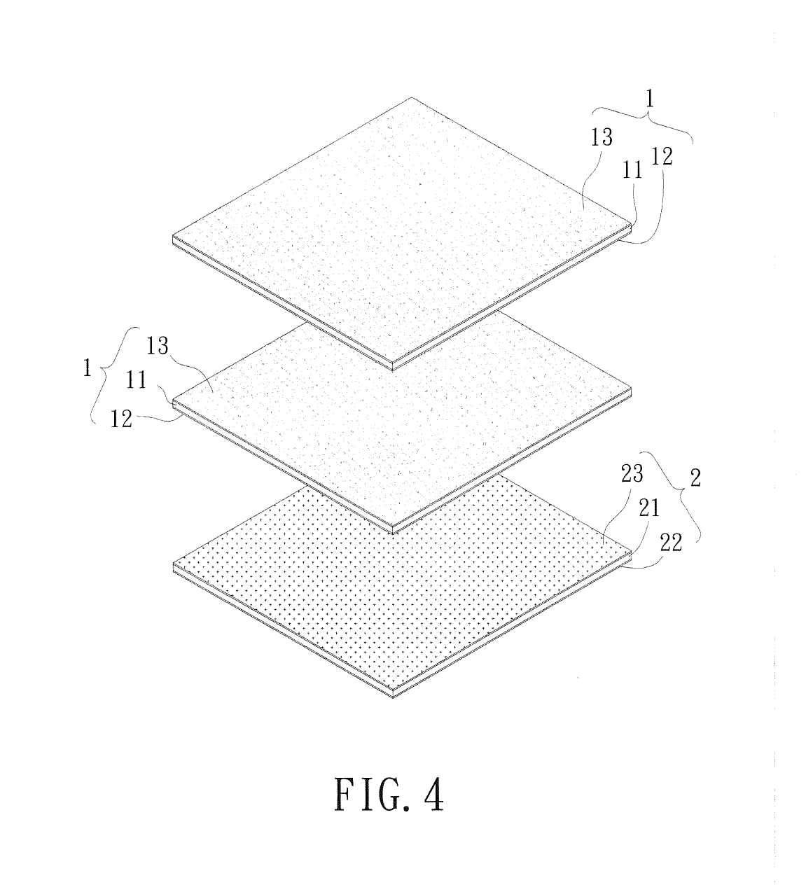

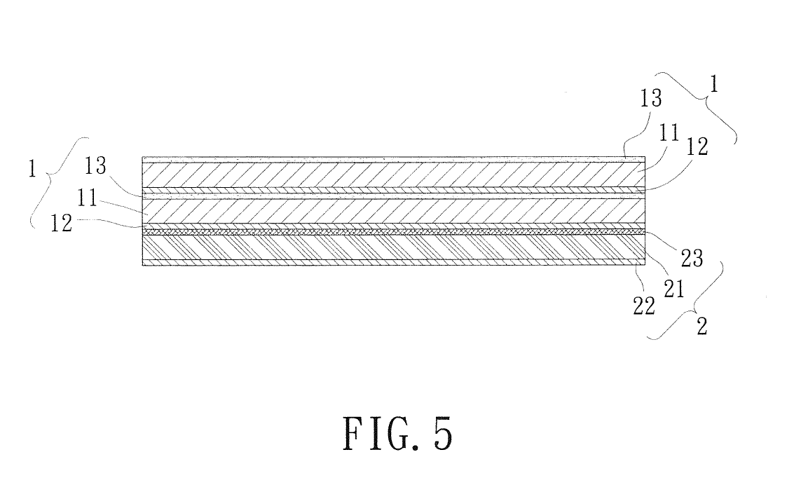

Moreover, if customer designates a screen protector having fragrance and bacteriostatic functions, referring to FIG. 4 and FIG. 5, one anti-scratch bacteriostatic film 2 and two fragrance films 1 can be overlapped sequentially from bottom to top to form a three-film structure screen protector with one anti-scratch bacteriostatic film 2 and two fragrance films 1. When this screen protector formed in this way is adhered to the screen of mobile phone or computer, bacteria attached to the screen can be eliminated by the bacteriostatic component contained in the anti-scratch bacteriostatic layer 23 so as to protect users from sick due to invasion of bacteria into user's body through either mouth or nose. Additionally, fragrant aroma can be released from the essence oil contained in the fragrance layer 13 so that users can relieve both physical and mental fatigue feeling after smelling the fragrant aroma, and the odor attached to the screen of mobile phone can also be eliminated.

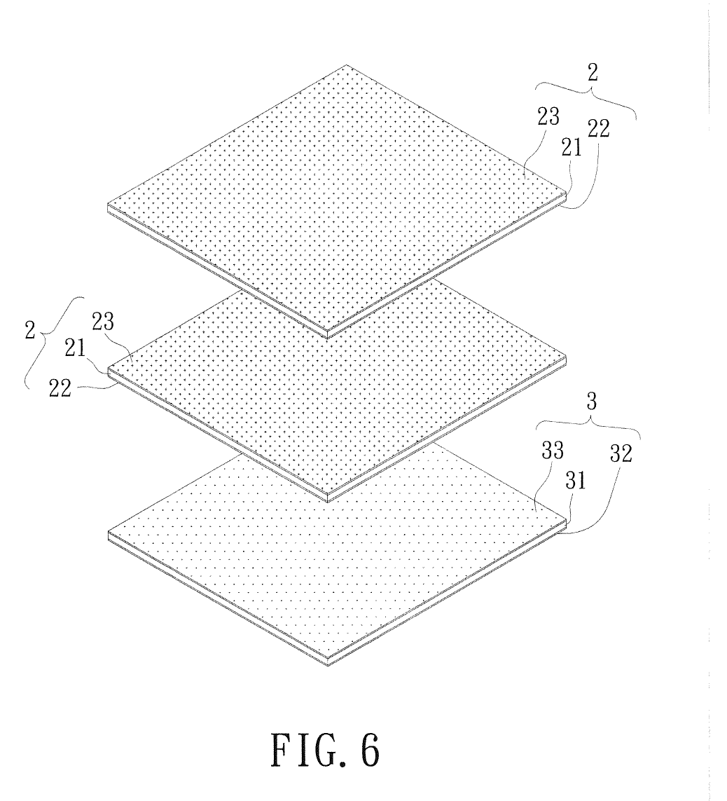

Moreover, if customer designates a screen protector having blue light reduction and bacteriostatic functions, referring to FIGS. 6 & 7, one anti-scratch blue light reduction film 3 and two anti-scratch bacteriostatic film 2 can be overlapped sequentially from bottom to top to form a three-film structure screen protector with one anti-scratch blue light reduction film 3 and two anti-scratch bacteriostatic films 2. When this screen protector formed in this way is adhered to the screen of a mobile phone or a computer, damage to user's eyes caused by irradiation of blue light emitted from the screen can be avoided and bacteria attached to the screen can be eliminated so as to protect users from sick.

Further, if customer designates a screen protector focusing on single function of bacteriostatics or blue light reduction, three pieces of anti-scratch bacteriostatic films 2 or three pieces of anti-scratch blue light reduction films 3 can be overlapped sequentially from bottom to top to form a three-film structure screen protector with three pieces of anti-scratch bacteriostatic film 2 or three pieces of anti-scratch blue light reduction films 3. Therefore, when this screen protector is adhered to the screen of mobile phone or computer, the performance of eliminating bacteria attached to the screen to protect users from sick can be further enhanced, or the performance of suppress the blue light emitted from the screen of mobile phone or computer to protect users' eyes from damaging can be further enhanced. If customer further wants the screen protector to have anti-static function, the anti-scratch antistatic film 4 can be assembled in the functional films so that attachment of dust or particles in the air to the screen surface due to electrostatic action can be avoided by the anti-scratch antistatic layer 43 of the anti-scratch antistatic film 4. Therefore, the screen surface can be maintained in clean state.

Based on foregoing, the screen protector of the present invention is formed by overlapping the functional films such as the fragrance film 1, the anti-scratch bacteriostatic film 2, the anti-scratch blue light reduction film 3 and the anti-scratch antistatic film 4 together, so that the screen protector has both a variety of functions and improved strength. Moreover, the production of screen protector designated by customer can be achieved more simply and more quickly by the modular design of the present invention. In addition, as adhesion is adopted in assembly between two functional films, users can easily tear off the upmost functional film when it is out of function, and replace with a new one. User can also purchase a functional film he wants so as to change the function of the screen protector by himself. Taking the fragrance film 1 as example, when the fragrance layer 13 of the upmost fragrance film 1 is out of function after use for a period of time, user can tear off the upmost fragrance film 1 and replace with a new fragrance film 1. It is very easy for user to change the fragrance film 1 to another one with different aroma or function, without disposing the whole screen protector. Therefore, not only user's economic burden can be lessened but also waste of resource can be avoided.

The abovementioned embodiment and drawings are not to limit the implementation aspect of the screen protector of the present invention. The screen protector of the present invention can also be adapted to the automobile glass, in addition to the screen of notebook PC, tablet, mobile phone, digital camera, etc.

What is claimed is:

1. A screen protector having a plurality of functional films, each of the functional films having a substrate and an adhesive layer being combined on the bottom face of the substrate; the screen protector being formed by overlapping the plurality of functional films together in such a manner that the adhesive layer on the bottom face of one functional film is adhered to the functional layer provided on the top face of adjacent functional film.

2. The screen protector as claimed in claim 1, wherein the plurality of functional films can be one selected from: at least one fragrance film with a fragrance layer as its functional layer, at least one anti-scratch bacteriostatic film with an anti-scratch bacteriostatic layer as its functional layer, at least one anti-scratch blue light reduction film with an anti-scratch blue light reduction layer as its functional layer, at least one anti-scratch antistatic film with an anti-scratch antistatic layer as its functional layer, or the combination thereof.

3. The screen protector as claimed in claim 2, wherein the plurality of functional films comprises one anti-scratch blue light reduction film and two fragrance films in which the anti-scratch blue light reduction film is disposed as the bottom, film and the two fragrance films are sequentially overlapped over the anti-scratch blue light reduction film.

4. The screen protector as claimed in claim 2, wherein the plurality of functional films comprises one anti-scratch bacteriostatic film and two fragrance films in which the anti-scratch bacteriostatic film is disposed as the bottom film and the two fragrance films are sequentially overlapped over the anti-scratch bacteriostatic film.

5. The screen protector as claimed in claim 2, wherein the plurality of functional films comprises one anti-scratch blue light reduction film and two anti-scratch bacteriostatic films in which the anti-scratch blue light reduction film is disposed as the bottom film and the two anti-scratch bacteriostatic films are sequentially overlapped over the to anti-scratch blue light reduction film.

6. The screen protector as claimed in claim 2, wherein the plurality of functional films comprises three pieces of anti-scratch bacteriostatic films sequentially overlapped together.

7. The screen protector as claimed in claim 2, wherein the fragrance layer of the fragrance film is formed by mixing a porous material having a plurality of micro pores, essence and resin together.

8. The screen protector as claimed in claim 2, wherein the anti-scratch bacteriostatic layer of the anti-scratch bacteriostatic film is formed by mixing a group containing metal ions of Fe, Co, Ni, Zn, and Ti, one of nano silver and nano copper, anti-scratch particles, and resin together.

9. The screen protector as claimed in claim 2, wherein the blue light reduction layer of the anti-scratch blue light reduction film is formed by mixing an optical filtering particles made by one of metal and glass, pigment, florescent pigment, anti-scratch particles, and resin together.

10. The screen protector as claimed in claim 2, wherein the antistatic layer of the anti-scratch antistatic film is formed by mixing an antistatic agent, anti-scratch particles, and resin together.
